(19) United States
(12) Patent Application Publication
(10) Pub. No.: US 2024/0348423 A1
(43) Pub. Date: Oct. 17, 2024

(54) INFORMATION RETRIEVAL METHOD AND APPARATUS, COMPUTER DEVICE, AND STORAGE MEDIUM

(71) Applicants: ZJU-HANGZHOU GLOBAL SCIENTIFIC AND TECHNOLOGICAL INNOVATION CENTER, Hangzhou (CN); HANGZHOU CITY BRAIN CO., LTD., Hangzhou (CN)

(72) Inventors: Jian LIU, Hangzhou (CN); Jingyu LI, Hangzhou (CN); Di WU, Hangzhou (CN); Kui REN, Hangzhou (CN); Yongsheng SHEN, Hangzhou (CN)

(21) Appl. No.: 18/387,261

(22) Filed: Nov. 6, 2023

Related U.S. Application Data
(63) Continuation-in-part of application No. PCT/CN2023/110117, filed on Jul. 31, 2023.

(30) Foreign Application Priority Data
Apr. 3, 2023 (CN) 202310360451.5
Jul. 26, 2023 (CN) 202310925371.X

(51) Int. Cl. H04L 9/06

(52) U.S. Cl. CPC H04L 9/06

(57) ABSTRACT

An information retrieval method and apparatus, a computer device, and a storage medium are provided. The method includes receiving a request ciphertext sent by a client, the request ciphertext including an encrypted first code, the first code being generated based on a request entry of the client and a preset encoding algorithm; performing distributed matching on a plurality of candidate codes based on the request ciphertext to determine a second code matching the request ciphertext, the candidate codes being generated based on index entries of a database and the preset encoding algorithm; and sending a request information ciphertext associated with the index entry corresponding to the second code to the client.

### CROSS REFERENCE TO RELATED APPLICATIONS

This application is a Continuation-in-Part of PCT Patent Application No. PCT/CN2023/110117, entitled “INFORMATION RETRIEVAL METHOD AND APPARATUS, COMPUTER DEVICE, AND STORAGE MEDIUM”, filed on Jul. 31, 2023, which claims priority to Chinese Patent Application No. 202310360451.5, entitled “INFORMATION RETRIEVAL METHOD AND APPARATUS, COMPUTER DEVICE, AND STORAGE MEDIUM” and filed on Apr. 3, 2023 and Chinese Patent Application No. 202310925371.X, entitled “INFORMATION RETRIEVAL METHOD AND APPARATUS, COMPUTER DEVICE, AND STORAGE MEDIUM” and filed on Jul. 26, 2023, the entire contents of which are incorporated herein by reference.

### TECHNICAL FIELD

The present disclosure relates to the field of data processing technologies, and in particular, to an information retrieval method and apparatus, a computer device, and a storage medium.

### BACKGROUND

With rapid development of the Internet, database services based on cloud servers have become a mainstream technology. In this context, query information of a user may be exposed to a service provider that provides a related service, resulting in a large number of security risks during a query. Importance of private information retrieval becomes increasingly prominent. The private information retrieval is defined as ensuring that a holder of a database cannot acquire any relevant information about the user's retrieval while the user retrieves required data from the database.

In the related art, in order to ensure privacy and security of the retrieval process, a server generally receives an encrypted query request and matches index entries of the database one by one through a ciphertext to determine information to be queried for by the user. However, the private information retrieval technology in the related art cannot be well applied to large databases, and required retrieval time cannot meet an actual requirement. For example, for a database with 131072 index entries and a size of 1.3 GB, it takes 680 s to complete a query in the related art. Therefore, the private information retrieval in the related art has a high computational cost and low retrieval efficiency.

No effective solution has yet been proposed with respect to the technical problems of the high computational cost and low retrieval efficiency of the private information retrieval in the related art.

### SUMMARY

According to various embodiments of the present disclosure, an information retrieval method and apparatus, a computer device, and a storage medium are provided.

In a first aspect, the present disclosure provides an information retrieval method, including:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm;
sending a request information ciphertext associated with the index entry corresponding to the second code to the client.

In an embodiment, the process of performing distributed matching on the plurality of candidate codes based on the request ciphertext includes:
determining a plurality of first sequence positions corresponding to a preset character based on the candidate codes;
acquiring all target characters corresponding to the first sequence positions in the request ciphertext, and determining a matching result based on a product result of all the target characters.

In an embodiment, the acquiring all the target characters corresponding to the first sequence positions in the request ciphertext, and determining the matching result based on the product result of all the target characters includes:
performing a rotation operation on the request ciphertext sequentially based on each of the first sequence positions to obtain a plurality of rotated ciphertexts, a character at a preset sequence position in each of the rotated ciphertexts being the same as a character at the first sequence position in the corresponding request ciphertext;
acquiring target rotated characters corresponding to the preset sequence positions in the plurality of rotated ciphertexts, and determining the matching result based on a product result of all the target rotated characters.

In an embodiment, a number of the first sequence positions corresponding to each of the candidate codes is the same, and the performing distributed matching on the plurality of candidate codes based on the request ciphertext to determine the second code matching the request ciphertext includes:
during each round of rotation, performing the rotation operation on the request ciphertext simultaneously based on the first sequence positions of the plurality of candidate codes to obtain the plurality of rotated ciphertexts and superimpose the plurality of rotated ciphertexts to obtain a combined rotated ciphertext;
acquiring the target rotated character corresponding to each of the preset sequence positions in the plurality of combined rotated ciphertexts obtained during a plurality of rounds of rotation, and determining a matching result of the corresponding candidate code based on a product result of all the target rotated characters corresponding to each of the preset sequence positions.

In an embodiment, after the performing distributed matching on the plurality of candidate codes based on the request ciphertext to determine the second code matching the request ciphertext, the method further includes:
establishing a selection vector, each component in the selection vector corresponding to a matching result of one of the candidate codes;
determining the request information ciphertext associated with the index entry corresponding to the second code based on the selection vector and a plurality of index code information corresponding to the plurality of candidate codes.

In an embodiment, the components of the selection vector include a binary number 0 corresponding to a non-matching result and a binary number 1 corresponding to a matching result, and the determining the request information ciphertext associated with the index entry corresponding to the second code based on the selection vector and the plurality of index code information corresponding to the plurality of candidate codes includes:
performing, when lengths of the index code information are no higher than a preset threshold, a multiplication operation on the selection vector and an index information group to obtain the request information ciphertext;
cutting, when the lengths of the index code information are higher than the preset threshold, each of the index code information separately to obtain a plurality of sub index information groups, and rotating and adding a multiplication result of the selection vector and each of the sub index information groups to obtain the request information ciphertext.

In an embodiment, the determining the request information ciphertext associated with the index entry corresponding to the second code based on the selection vector and the plurality of index code information corresponding to the plurality of candidate codes includes:
performing a rotation operation on the selection vector to obtain a rotated selection vector, and rotating the index information group correspondingly based on the rotation operation on the selection vector, to obtain a rotated index information group;
determining the request information ciphertext associated with the index entry corresponding to the second code based on the rotated selection vector and the rotated index information group.

In an embodiment, each of the candidate codes is a binary string, the binary string including a preset number of binary numbers 1.

In a second aspect, the present disclosure further provides an information retrieval method, including:
generating a request ciphertext and sending the request ciphertext to a server, the request ciphertext including an encrypted first code, the first code being generated based on a request entry and a preset encoding algorithm;
receiving a request information ciphertext sent by the server, the request information ciphertext being an information ciphertext associated with an index entry corresponding to a second code matching the request ciphertext that is determined by the server after performing distributed matching on a plurality of candidate codes based on the request ciphertext, the candidate codes being generated based on an index entry of a database and the preset encoding algorithm;
decrypting the request information ciphertext to acquire request information.

In a third aspect, the present disclosure further provides an information retrieval apparatus, including:
a receiving module configured to receive a request ciphertext sent by a client, the request ciphertext including an encrypted first code, the first code being generated based on a request entry of the client and a preset encoding algorithm;
a matching module configured to perform distributed matching on a plurality of candidate codes based on the request ciphertext to determine a second code matching the request ciphertext, the candidate codes being generated based on index entries of a database and the preset encoding algorithm;
a sending module configured to send a request information ciphertext associated with the index entry corresponding to the second code to the client.

In a fourth aspect, the present disclosure further provides a computer device. A computer device, including a memory and a processor, a computer program being stored in the memory, wherein the processor, when executing the computer program, implements the following steps:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on an index entry of a database and the preset encoding algorithm; and
sending a request information ciphertext associated with the index entry corresponding to the second code to the client.

In a fifth aspect, the present disclosure further provides a computer-readable storage medium. The computer-readable storage medium stores a computer program, wherein when the computer program is executed by a processor, the following steps are implemented:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm; and
sending a request information ciphertext associated with the index entry corresponding to the second code to the client.

In a sixth aspect, the present disclosure further provides a computer program product. The computer program product includes a computer program, wherein when the computer program is executed by a processor, the following steps are implemented:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm; and
sending a request information ciphertext associated with the index entry corresponding to the second code to the client.

Details of one or more embodiments of the present disclosure are set forth in the following accompanying drawings and descriptions. Other features, objectives, and advantages of the present disclosure become obvious with reference to the specification, the accompanying drawings, and the claims.

### BRIEF DESCRIPTION OF THE DRAWINGS

In order to better describe and illustrate embodiments and/or examples of those inventions disclosed herein, reference may be made to one or more accompanying drawings. Additional details or examples used to describe the accompanying drawings should not be considered as limitations on the scope of any of the disclosed inventions, the presently described embodiments and/or examples, and the presently understood best mode of these inventions.

FIG. 1 is a diagram of an application environment of an information retrieval method according to one or more embodiments;

FIG. 2 is a schematic flowchart of an information retrieval method according to one or more embodiments;

FIG. 3 is a schematic flowchart of database processing according to one or more embodiments;

FIG. 4 is a schematic flowchart of database processing according to one or more embodiments;

FIG. 5 is a schematic flowchart of an information retrieval method according to one or more embodiments;

FIG. 6 is a structural block diagram of an information retrieval apparatus according to one or more embodiments; and

FIG. 7 is a diagram of an internal structure of a computer device according to one or more embodiments.

### DETAILED DESCRIPTION OF THE EMBODIMENTS

The technical solutions in embodiments of the present disclosure will be described clearly and completely below with reference to the accompanying drawings in the embodiments of the present disclosure. Apparently, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

In order to make the objectives, technical solutions, and advantages of the present disclosure clearer, the present disclosure will be further described in detail below with reference to the accompanying drawings and embodiments. It should be understood that specific embodiments described herein are only intended to explain the present disclosure and are not intended to limit the present disclosure.

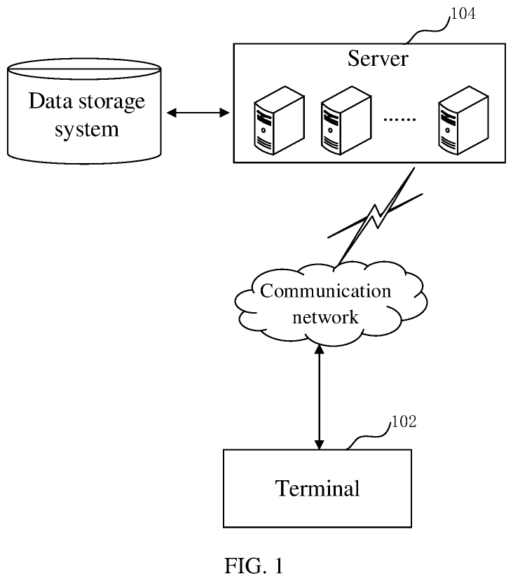

An information retrieval method provided in embodiments of the present disclosure may be applied to an application environment as shown in FIG. 1. A terminal 102 communicates with a server 104 via a network. A data storage system may store data to be processed by the server 104. The data storage system may be integrated onto the server 104, and may alternatively be placed on a cloud or other network servers. The terminal 102 may be but is not limited to various personal computers, notebook computers, smart phones, tablet computers, Internet of things devices, or portable wearable devices. The Internet of things devices may be smart speakers, smart televisions, smart air conditioners, smart in-vehicle devices, or the like. The portable wearable devices may be smart watches, smart bracelets, headsets, or the like. The server 104 may be implemented by a standalone server or a server cluster composed of a plurality of servers.

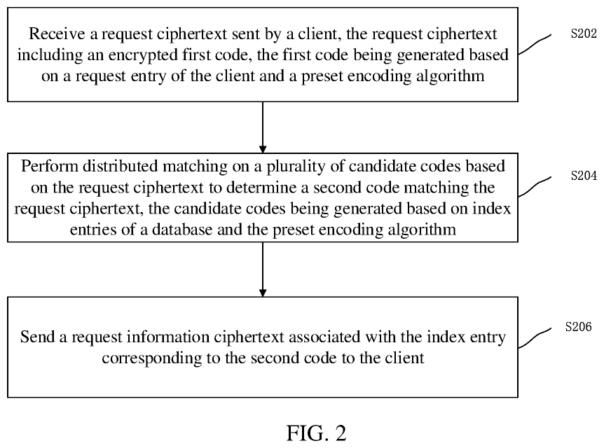

Referring to FIG. 2, FIG. 2 is a schematic flowchart of an information retrieval method according to an embodiment of the present disclosure.

In an embodiment, as shown in FIG. 2, the information retrieval method includes the following steps.

In S202, a request ciphertext sent by a client is received, the request ciphertext includes an encrypted first code, and the first code is generated based on a request entry of the client and a preset encoding algorithm.

Specifically, the information retrieval method in this embodiment is applied to a server, the server is provided with a database, and the server is connected to at least one client. During information query, the server receives the request ciphertext sent by the client, and processes the request ciphertext in an encrypted environment.

In this embodiment, a process of generating the request ciphertext involves: acquiring, by the client, a request entry inputted by a user, wherein the request entry is a data entry to be queried for by the user in a server database (i.e., request information); encoding the request entry based on the preset encoding algorithm to generate the first code; and encrypting the first code based on the preset encoding algorithm to generate the request ciphertext. It may be understood that the request ciphertext includes an index entry to be acquired by the user from the database (i.e., the request entry).

Optionally, in this embodiment, a range of the request entry is limited to a range of all index entries in the database, and the server may directly determine, from all the index entries, an index entry the same as the request entry to achieve precise search.

Exemplarily, the request entry and the index entry in this embodiment include, but are not limited to, serial number entries, keyword entries, and combinations of serial number entries and keyword entries.

In S204, distributed matching is performed on a plurality of candidate codes based on the request ciphertext to determine a second code matching the request ciphertext, and the candidate codes are generated based on index entries of a database and the preset encoding algorithm.

Specifically, in this embodiment, after receiving the request ciphertext, the server matches the plurality of candidate codes in parallel through distributed processing, so as to determine the second code matching the first code in the request ciphertext.

In this embodiment, a process of generating the candidate codes involves: acquiring all index entries in the database; and encoding each index entry separately based on the preset encoding algorithm to generate the candidate codes. It is to be noted that, in this embodiment, the first code and the candidate code are both generated based on the preset encoding algorithm. That is, the first code and the candidate code are encoded in a same manner.

In S206, a request information ciphertext associated with the index entry corresponding to the second code is sent to the client.

Specifically, after retrieving the second code matching the request ciphertext, the server determines a corresponding index entry in the database based on the second code, and sends encrypted information associated with the index entry, i.e., the request information ciphertext, to the client. After receiving the request information ciphertext, the client decrypts the ciphertext, so as to obtain request information.

Exemplarily, in this embodiment, private information retrieval can be realized based on a homomorphic encryption technology. The homomorphic encryption technology is a scheme in which encrypted data is allowed to be directly computed without being decrypted with a secret key. The homomorphic encryption technology can ensure that an information retrieval process is performed in an encrypted environment.

In this embodiment, a request ciphertext sent by a client is received, the request ciphertext includes an encrypted first code, and the first code is generated based on a request entry of the client and a preset encoding algorithm. Distributed matching is performed on a plurality of candidate codes based on the request ciphertext to determine a second code matching the request ciphertext, and the candidate codes are generated based on index entries of a database and the preset encoding algorithm. A request information ciphertext associated with the index entry corresponding to the second code is sent to the client. In the present disclosure, the server processes a request from the user in an encrypted environment and returns encrypted request information to the client, so that the server cannot know a query object of the client while the client uses a database query service normally. At the same time, the server simultaneously performs correlation retrieval on the plurality of candidate codes through distributed processing, so that the retrieval process can support batch processing operations, which solves the technical problems of the high computational cost and low retrieval efficiency of the private information retrieval in the related art, leads to lower amortized overhead and faster processing of computing resources, and improves retrieval efficiency while ensuring privacy and security of the information retrieval process.

In another embodiment, the process of performing distributed matching on the plurality of candidate codes based on the request ciphertext includes:
step 1: determining a plurality of first sequence positions corresponding to a preset character based on the candidate codes; and
step 2: acquiring all target characters corresponding to the first sequence positions in the request ciphertext, and determining a matching result based on a product result of all the target characters.

Specifically, in this embodiment, the server simultaneously processes the plurality of candidate codes through distributed processing, and a process of processing each candidate code includes: selecting a preset character, wherein the preset character is one of several encoding characters in the candidate code, and determining, in the candidate code, all encoding positions corresponding to the preset character, i.e., the first sequence positions; and acquiring characters at all encoding positions the same as the first sequence positions, i.e., the target characters, in the request ciphertext, calculating a product result of all the target characters, and determining, based on the product result, whether the current candidate code matches the request ciphertext.

It may be understood that, since the information retrieval method in this embodiment is performed in the encrypted environment, the server cannot directly read the first code in the request ciphertext and then directly match the first code and the candidate code in terms of content similarity. Therefore, there is a need to extract a character at a specific encoding position in the request ciphertext, and determine, based on a processing result of the character at the specific encoding position, whether the first code and the candidate code match.

It may be understood that, since the first code and the candidate code are encoded in the same manner, when the request entry and the index entry are the same, the first code and the candidate code corresponding to the index entry are also the same. For example, when the first code and the candidate code are both decimal numbers and the preset character is set to 2, if there are k characters at the first sequence position in the candidate code that are 2, target characters at k encoding positions the same as the first sequence position in the request ciphertext are extracted, and a product result of all the target characters is calculated. In a case where the candidate code is the same as the first code in the request ciphertext, the product result outputted should be 2^{k}. If an output result after the processing on the request ciphertext is not equal to 2^{k}, it indicates that the current candidate code is different from the first code.

Exemplarily, both the candidate code and the first code consist of binary numbers. After the server receives the request ciphertext sent by the client, since there is no corresponding key to decrypt the request ciphertext, all calculation operations of the server are performed based on the request ciphertext. A character at a specific encoding position of the first code in the request ciphertext is extracted and compared with the candidate code to obtain a processing result. A specific calculation function is as follows:

$$f ( x , y ) = \{ \begin{matrix}1 , & x = y \\ 0 , & x \neq y\end{matrix}$$

where x denotes the first code of the request ciphertext, y denotes the candidate code, and f (x,y) denotes a comparison result between the first code and the candidate code. If the first code x is the same as the candidate code y, the comparison result f (x,y) is 1. Otherwise, if the first code x is different from the candidate code y, the comparison result f (x, y) is 0.

Further, a specific process of comparing the first code x with the candidate code y is implemented through the following function:

$$f ( x , y ) = {\prod }_{y [ i ] = 1} x [ i ]$$

where i denotes encoding positions of the first code x and the candidate code y. A calculation process in the above function involves: acquiring all encoding positions of a preset character y [i]=1 in the candidate code y, that is, the first sequence position i, extracting, in the first code x, all target characters x [i] at the encoding positions the same as the first sequence position i, and calculating a product result of all the target characters x [i]. It may be understood that, if the first code x is the same as the candidate code y, the product result of the target characters x [i] is 1.

In this embodiment, target characters at a specific position of the request ciphertext are extracted, a product operation is performed on the target characters to obtain a processing result, and then it is determined based on the processing result whether the candidate code matches the request ciphertext, which ensures a simple calculation process while the matching process is performed in an encrypted environment, thereby reducing a computational cost of information retrieval.

In another embodiment, the acquiring all the target characters corresponding to the first sequence positions in the request ciphertext, and determining the matching result based on the product result of all the target characters includes:
step 1: performing a rotation operation on the request ciphertext sequentially based on each of the first sequence positions to obtain a plurality of rotated ciphertexts, a character at a preset sequence position in each of the rotated ciphertexts being the same as a character at the first sequence position in the corresponding request ciphertext; and
step 2: acquiring target rotated characters corresponding to the preset sequence positions in the plurality of rotated ciphertexts, and determining the matching result based on a product result of all the target rotated characters.

Specifically, a process of acquiring the target characters corresponding to the first sequence positions in the request ciphertext and calculating the product result includes: sequentially acquiring each first sequence position, and performing a rotation operation on a vector of the request ciphertext based on the first sequence position, so that characters at the preset sequence position in the rotated ciphertext are characters at the first sequence position, thereby obtaining the plurality of rotated ciphertexts corresponding to the plurality of first sequence positions. It may be understood that the preset sequence positions in different rotated ciphertexts are the same. For example, the preset sequence position is the first position in the rotated ciphertext ũₐ, where a ∈ [1, k], k denotes a number of the first sequence positions, and ũₐ [1]=x [i] is obtained for a rotated ciphertext corresponding to each first sequence position i.

Specifically, after rotated ciphertexts corresponding to the plurality of first sequence positions are acquired, target rotated characters at the preset sequence positions in the plurality of rotated ciphertexts are extracted, a product result of all the target rotated characters is calculated, and the matching result is determined based on the product result. For example, taking binary numbers as an example, the preset character is set to 1. When the first code and the candidate code are the same, the characters at the first sequence position in the request ciphertext should all be 1, target rotated characters at the preset sequence position in the rotated ciphertext obtained after rotation should also be 1, and a final product result is 1. If the final product result calculated is 0, it may be determined that the request ciphertext does not match the current candidate code.

Exemplarily, when the preset sequence position is the first position of the request ciphertext, a calculation formula of the product result v is as follows:

$$v = {\prod }_{a = 1}^{k} {ũ}_{a} [ 1 ]$$

Exemplarily, in each candidate code y after index entries of the database are encoded, there are encoding characters 1 at k positions. For each y [i]=1, the first code x in the request ciphertext is rotated based on the position i, and the rotated request ciphertext fills a data slot to obtain a rotated ciphertext ũₐ, where ũₐ [1]=x [i]. After k rotations, ciphertexts [ũ₁, ũ₂, . . . , ũₖ] corresponding to the k positions are multiplied by using ciphertext multiplication in the homomorphic encryption technology to obtain a selection vector, i.e., a product result \tilde{v}, where

$$\tilde{v} [ 1 ] = {\prod }_{y [ i ] = 1} x [ i ]$$

Exemplarily, for the first position of the product result in the above formula, if the request entry is the current index entry, that is, the candidate code y is the same as the first code x, \tilde{v}[1]=1. If the requested entry is not the current index entry, that is, the candidate code y is different from the first code x, \tilde{v}[1]=0. Through the above specific embodiments, it can be determined whether each candidate code y is the same as the first code x.

Exemplarily, this example further provides relevant code to implement the above specific embodiments, specifically as follows:

```
input: [\tilde{x}₁, ... , \tilde{x}ₜ] and y, where x₁||...||xₜ=x
output: \tilde{v}:when x=y, v[1]=1 otherwise 0; o.w.v=o^{N}
  search y for k indexes [i₁,...,iₖ], where y[i]=1
  a:=1
  for i ∈ [i₁,...,iₖ] do
    j:=[i/N]
    c:=1%N−1
    Ũₐ ← SIMDRotate(\tilde{x}ⱼ, c)
    a:= a+1
  end for
  \tilde{V} := SIMDMul(ũ₁, ũ₂, ... , ũₖ)
  e:=0^{N},e[1]:=1
  \tilde{V} ← SIMDPmul(\tilde{v}, e)
```

In this embodiment, in a manner of rotating the request ciphertext, target characters corresponding to the first sequence position are rotated to a preset sequence position to obtain target rotated characters, and all the target rotated characters at the preset sequence position are processed to obtain a matching result, so as to match the candidate codes in an encrypted environment, thereby ensuring privacy of information retrieval.

In another embodiment, a number of the first sequence positions corresponding to each of the candidate codes is the same, and the performing distributed matching on the plurality of candidate codes based on the request ciphertext to determine the second code matching the request ciphertext includes:
step 1: during each round of rotation, performing the rotation operation on the request ciphertext simultaneously based on the first sequence positions of the plurality of candidate codes to obtain the plurality of rotated ciphertexts and superimpose the plurality of rotated ciphertexts to obtain a combined rotated ciphertext; and
step 2: acquiring the target rotated character corresponding to each of the preset sequence positions in the plurality of combined rotated ciphertexts obtained during a plurality of rounds of rotation, and determining a matching result of the corresponding candidate code based on a product result of all the target rotated characters corresponding to each of the preset sequence positions.

Specifically, in this embodiment, the number of the first sequence positions corresponding to each candidate code is the same, so as to ensure that the plurality of candidate codes can be synchronized at the same time. It may be understood that, for each first sequence position, the request ciphertext is required to be rotated once. When the number of the first sequence positions corresponding to each candidate code is the same, a required number of rotations of the request ciphertext is also the same.

Specifically, in this embodiment, the plurality of candidate codes are processed simultaneously. It is set that the number of the candidate codes is N, the number of the first sequence positions in each candidate code is k, and the first sequence position is i_{pq}, where p∈ [1,N] and q∈ [1,k]. During the first round of rotation, a plurality of first sequence positions iₚₗ in the plurality of candidate codes are acquired simultaneously, a rotation operation is performed on the request ciphertext based on each first sequence position iₚₗ to obtain N rotated ciphertexts and superimpose the N rotated ciphertexts to obtain a combined rotated ciphertext. The above process is repeated until k rounds of rotation are completed, and k combined rotated ciphertexts are obtained.

In this embodiment, superimposing the rotated ciphertexts means splicing codes of the plurality of rotated ciphertexts in order of the rotated ciphertexts to obtain a spliced combined rotated ciphertext.

It may be understood that, since there is a preset sequence position in the rotated ciphertext and the preset sequence positions in different rotated ciphertexts are the same, there are N preset sequence positions in the combined rotated ciphertext and the N preset sequence positions in different combined rotated ciphertexts are all the same.

Specifically, after k rounds of rotation operations are completed, k combined rotated ciphertexts are obtained. In each combined rotated ciphertext, the target rotated characters corresponding to the N preset sequence positions in each combined rotated ciphertext are acquired sequentially, and a product result of k target rotated characters corresponding to a same preset sequence position is calculated, so as to obtain final N product results. It is judged based on each product result whether the corresponding candidate code matches the request ciphertext. “A product result of k target rotated characters corresponding to a same preset sequence position is calculated” means calculating, after k rounds of rotation operations are completed, a product result of k target rotated characters corresponding to a same preset sequence position in the k combined rotated ciphertexts. N product results can be obtained from N preset sequence positions. Exemplarily, the solution in this embodiment may be implemented through the homomorphic encryption technology, which can reduce the computational cost by using a characteristic in the homomorphic encryption technology that N data slots can be used for synchronous calculations at the same time. Specific steps are as follows. In a process of simultaneously matching N candidate codes, the request ciphertext is rotated into N data slots respectively, instead of being rotated into a single data slot one after another. After the rotation is completed, data in the data slot is cleared by using plain-ciphertext multiplication, N results after the clearing are superimposed, and the above steps are repeated until k rounds of rotation of the request ciphertext are completed. Multiplication is performed by using superimposed results in each round of rotation, so as to obtain a product result of the N candidate codes by batch computing.

It may be understood that, through the solution in this embodiment, a ciphertext multiplication operation with a high computational cost can be reduced from N (k−1) times to k−1 times, thereby significantly reducing the computational cost.

Exemplarily, this example further provides relevant code to implement the above specific embodiments, specifically as follows:

```
input: [\tilde{x}₁,..., \tilde{x}ₜ] and [y₁, ... , y_{N}], where x₁||...||xₜ=x
output: \tilde{v}: for each 1 ∈ [N], when x=y₁, v[1]=1; o.w. v[1]=0
  initialize [\tilde{w}₁,..., \tilde{w}ₖ]: each \tilde{w}ᵢ is a 0^{N} encrypted ciphertext
  for 1:=1,..., N do
    search y₁ for k positions [i₁,...,iₖ], satisfy y₁[i]=1
    a:=1
    for i ∈ [i₁,...,iₖ] do
      j:=[i/N]
      c:=1%N−1
      Ũ ← SIMDRotate(\tilde{x}ⱼ, c)
      e:=0^{N},e[1]:=1
      Ũ ← SIMDPmul(ũ, e)
      \tilde{W}ₐ := SIMDAdd(\tilde{w}ₐ, ũ)
      a:=a+1
    end for
end for
\tilde{v} := SIMDMul(ũ₁, ũ₂, ... , ũₖ)
return \tilde{v}
```

In this embodiment, a plurality of candidate codes are matched simultaneously based on parallel processing, so as to improve matching efficiency of the candidate codes and reduce the computational cost, thereby improving efficiency of information retrieval.

In another embodiment, after the performing distributed matching on the plurality of candidate codes based on the request ciphertext to determine the second code matching the request ciphertext, the method further includes:
step 1: establishing a selection vector, each component in the selection vector corresponding to a matching result of one of the candidate codes; and
step 2: determining the request information ciphertext associated with the index entry corresponding to the second code based on the selection vector and a plurality of index code information corresponding to the plurality of candidate codes.

Specifically, in this embodiment, after the matching process for each candidate code is completed, one component in the selection vector is determined based on a matching result of the candidate code, and the selection vector is established based on the component corresponding to each candidate code. Each component in the selection vector is used to identify whether the corresponding candidate code matches the request ciphertext. Therefore, the request information ciphertext associated with the index entry corresponding to the second code can be directly determined through the selection vector and all index code information associated with the index entries of the database.

Exemplarily, if the candidate code matches the request ciphertext, the corresponding component in the selection vector is set to 1. Otherwise, if the candidate code does not match the request ciphertext, the corresponding component in the selection vector is set to 0, thereby obtaining a selection vector composed of binary numbers 0 and 1. The selection vector is multiplied by an index information group composed of index information of all the index entries in the database, components in a multiplication result are then added, and the content associated with the index entry matching the request entry, i.e., the request information ciphertext, can be retained.

In this embodiment, a matching result between each candidate code and the request ciphertext is recorded through the selection vector, and the request information ciphertext is directly extracted through the selection vector, so that the processing process is simple and easy to implement, thereby reducing the computational cost of information retrieval.

In another embodiment, the components of the selection vector include a binary number 0 corresponding to a non-matching result and a binary number 1 corresponding to a matching result, and the determining the request information ciphertext associated with the index entry corresponding to the second code based on the selection vector and the plurality of index code information corresponding to the plurality of candidate codes includes:
step 1: performing, when lengths of the index code information are no higher than a preset threshold, a multiplication operation on the selection vector and an index information group to obtain the request information ciphertext; and
step 2: cutting, when the lengths of the index code information are higher than the preset threshold, each of the index code information separately to obtain a plurality of sub index information groups, and rotating and adding a multiplication result of the selection vector and each of the sub index information groups to obtain the request information ciphertext.

Specifically, in this embodiment, if the candidate code matches the request ciphertext, the corresponding component in the selection vector is set to the binary number 1. Otherwise, if the candidate code does not match the request ciphertext, the corresponding component in the selection vector is set to the binary number 0, thereby establishing the selection vector.

Specifically, if the length of the index information ciphertext is shorter, that is, the length of the index information ciphertext is no higher than the preset threshold, the multiplication operation is directly performed on the selection vector and the index information group. When the index entry is the same as the request entry, the component corresponding to the candidate code of the index entry is 1, and the index information ciphertext of the index entry is retained after the multiplication operation. When the index entry is different from the request entry, the component corresponding to the candidate code of the index entry is 0, and the index information ciphertext of the index entry is eliminated after the multiplication operation. Through the above multiplication operation, the request information ciphertext can be obtained.

The index information group in this embodiment refers to a matrix established with each index information ciphertext as an element.

Specifically, if the length of the index information ciphertext is longer, that is, the length of the index information ciphertext is higher than the preset threshold, each index information ciphertext is first cut to obtain a plurality of sub index code information, and then all the sub index code information are combined to obtain a plurality of sub index information groups. For example, each index information ciphertext is cut to obtain 4 sub index code information, thereby obtaining 4 sub index information groups. The selection vector is multiplied by each sub index information group respectively to obtain a plurality of multiplication results, and the plurality of multiplication results are rotated and then added to obtain the request information ciphertext.

It may be understood that, through the operation of rotating and then adding the multiplication results, a data volume can be compressed so that the data slot can accommodate more information, thereby reducing a communication cost between the server and the client.

The preset threshold in this embodiment is determined based on an actual scenario requirement. Exemplarily, when processing is performed by using the homomorphic encryption technology, the data volume that can be accommodated in each data slot is determined by a plaintext modulus of the database. The plaintext modulus determines a size of plaintext data of the database, that is, unencrypted data, and budget consumption when the multiplication operation is performed, and the preset threshold can be determined through the plaintext modulus of the database.

Exemplarily, when the length of the index information ciphertext of each entry in the database is lower than the preset threshold, the selection vector is multiplied by the index information group of the database, so that a position queried for by the request entry of the client can be retained and the remaining positions can be cleared, and the request information ciphertext can be obtained by adding results after multiplication. After obtaining the request information ciphertext, the server sends the request information ciphertext to the client to complete the query operation. Specific implementation code for the above operations is as follows:

```
input: [\tilde{x}₁, ... , \tilde{x}ₜ] and [(y₁,pl₁),...,(y_{N},pl_{N})]
Output: \tilde{v}:assume x=yᵢ, then v[1%N]=plᵢ, other vs are 0
  S:=[n/N]
  for i:=1,...,s do
    input ([\tilde{x}₁, ... , \tilde{x}ₜ],..., [\tilde{x}_{(i-1)N+1}, ... , \tilde{x}_{iN}])
    output ũᵢ
    Ũᵢ ← SIMDPmul ( u_{I}, [pl_{(i-1)N+1}, ... , pl_{iN}] )
  end for
  \tilde{V} ← SIMDAdd(ũ₁, ... , ũₛ)
  return \tilde{v}
```

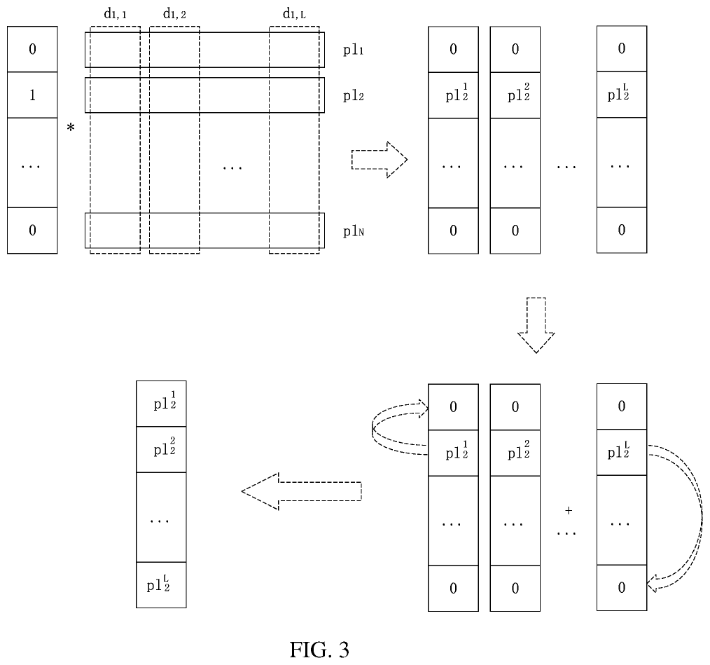

Referring to FIG. 3, FIG. 3 is a schematic flowchart of database processing according to an embodiment of the present disclosure.

Exemplarily, as shown in FIG. 3, when the length of the index information ciphertext of each entry in the database is higher than the preset threshold, there is a need to introduce a rotation operation. Firstly, each index information ciphertext plᵢ in index information groups pl₁, pl₂, . . . , and pl_{N} is cut, where i ∈ [1,N], and each index information ciphertext plᵢ is divided into L sub index code information, thereby obtaining L sub index information groups d_{1,1}, d_{1,2}, . . . , and d_{1,L}. Each sub index information group is multiplied by the selection vector to obtain L multiplication results [0,p₂¹,0, . . . ,0], [0,pl₂²,0, . . . ,0], . . . , and [0, pl₂^{L},0, . . . ,0]. In the L multiplication results, the index information ciphertext corresponding to the request entry is retained, and other index code information are cleared. The above L multiplication results are rotated and added to obtain a request information ciphertext [pl₂¹, pl₂², . . . , pl₂^{L}]. It may be understood that the above operation of rotating and adding the multiplication results can ensure that the request information ciphertext is in a same data slot, thereby reducing a communication volume between the server and the client.

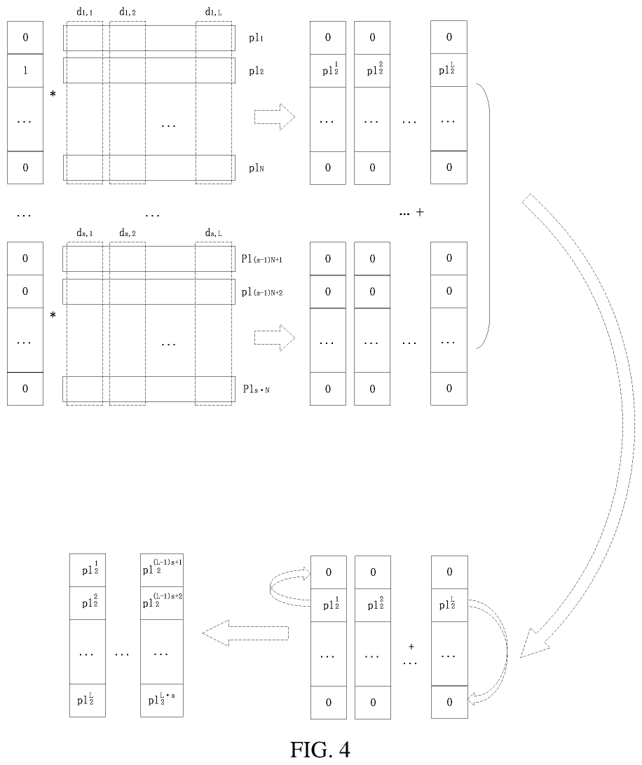

Referring to FIG. 4, FIG. 4 is a schematic flowchart of database processing according to another embodiment of the present disclosure.

Exemplarily, as shown in FIG. 4, in the case of a plurality of requests, the client sends a plurality of request ciphertexts to the server. In this case, the server can process the plurality of request ciphertexts in parallel and generate the request ciphertexts through the database processing method in this embodiment. Specifically, when there are s request ciphertexts, index entry matching is performed on each request ciphertext to obtain s selection vectors. Each selection vector is multiplied by a corresponding plurality of sub selection information groups to obtain a group of L multiplication results corresponding to each selection vector. There are sL multiplication results for the s selection vectors. s groups of multiplication results are added, and the results added are first rotated and then added in this embodiment to obtain final s groups of request information ciphertexts. Each group of request information ciphertexts is placed in a same data slot.

It may be understood that, through the method in the above embodiments, a longer request information ciphertext can be obtained when a space of the data slot and the communication cost are limited.

In this embodiment, corresponding operations are performed on the database based on the length of the index information ciphertext. When the index information ciphertext is shorter, a multiplication operation is directly performed to obtain the request information ciphertext. When the index information ciphertext is longer, cutting is performed first, then a multiplication operation is performed on each sub index information group, and multiplication results are rotated and then added to obtain a request information ciphertext. The processing logic is simple. Moreover, the rotation and addition operations can effectively reduce an occupation requirement of the data slot and the communication volume between the server and the client, better adapt to scenarios such as index query and keyword query, reduce additional communication and computing costs brought during the privacy query, and lower the overhead for scenarios where index entries of the database are larger.

In another embodiment, the determining the request information ciphertext associated with the index entry corresponding to the second code based on the selection vector and the plurality of index code information corresponding to the plurality of candidate codes includes:
step 1: performing a rotation operation on the selection vector to obtain a rotated selection vector, and rotating the index information group correspondingly based on the rotation operation on the selection vector, to obtain a rotated index information group; and
step 2: determining the request information ciphertext associated with the index entry corresponding to the second code based on the rotated selection vector and the rotated index information group.

Specifically, prior to the multiplication operation on the selection vector and the index information groups, the rotation operation is first performed on the selection vector, and at the same time, the index information groups are rearranged according to the rotation operation on the selection vector to ensure that the components in the selection vector still correspond to the index code information during the multiplication operation. After the above rotation operation is completed, the multiplication operation is performed on the rotated selection vector obtained by rotation and the rotated index information group, to obtain the request information ciphertext associated with the index entry corresponding to the second code.

It is to be noted that, in the present disclosure, the selection vector is a ciphertext, and the index information group is obtained by using a specific encoding manner for the index entries in the plaintext database. Therefore, the index information group is cryptographically defined as plaintext. Moreover, after the multiplication operation on the rotated selection vector and the rotated index information group, the obtained request information ciphertext is a ciphertext.

It may be understood that, in this embodiment, since rotation of plaintext is less expensive, the computational cost of rotation of the index information group can be ignored when computing resources are taken into account. At the same time, since an upper limit of a number of rotations of a ciphertext is determined by a number of index entries in the database and has nothing to do with a size of the index information ciphertext associated with each index entry, in a scenario where the length of the index information ciphertext of a single entry in the database is longer, the above operations can significantly reduce the number of rotations, thereby achieving higher retrieval efficiency.

Exemplarily, for a database with different data lengths associated with the index entries, a smaller number of rotations can be obtained through the operation of rotating the selection vector and the operation of performing multiplication and addition after rotation. For example, the number of the request information ciphertexts corresponding to the selection vector obtained through the above embodiments is s. If the selection vector is rotated α-1 times and rotated N/α slots each time, the number of rotations for the multiplication and addition operation after rotation of the index information group may be reduced by α times. In this case, a total number of rotations can be calculated:

$$f ( α ) = ( α - 1 ) s + ( \frac{N}{α} - 1 ) 1$$

where N denotes the number of index entries, α denotes a reduction factor, and l denotes a cutting coefficient for the index information ciphertext. Through analysis of a first-order derivative and a second-order derivative of the above function, minimum α of the total number of rotations of the database when data volumes of the index entries are different can be determined.

In this embodiment, a rotation operation is first performed on the selection vector, the index information groups are rearranged to obtain the rotated selection vector and the rotated index information group, and then the request information ciphertext of the index entry is determined based on the rotated selection vector and the rotated index information group, so as to realize compression of processed data, which can be applied to databases with different data volumes associated with index entries and has a wide range of application scenarios in various types of databases.

In another embodiment, each of the candidate codes is a binary string, and the binary string includes a preset number of binary numbers 1.

Specifically, in this embodiment, each of the candidate codes is a binary string. If the length of the candidate code is set to m, the candidate code is a binary string composed of binary numbers 0 and binary numbers 1. In the binary string, 1 is at a preset number k of positions, and 0 is at the remaining positions.

Exemplarily, the index entries of the database are encoded by using a constant-weight code encoding algorithm. The constant-weight code encoding algorithm is public to both the server and the client. Constant-weight code encoding is one of error correcting code, which consist of binary strings with a same Hamming distance k. A length of the string is set to m, and a size of an encoding space thereof is n different strings that meet a constant-weight code encoding condition. For a given Hamming distance k, the length m of the string required to be selected should satisfy:

$$m ∈ O ( \sqrt[k]{k ! n} + k )$$

where the function O(x) is expressed as a set of all positive integers less than or equal to x.

Exemplarily, the encoding scheme in this embodiment is implemented by using a single-instruction multiple-data stream technology of Chinese Remainder Theorem Encoding under a homomorphic encryption framework, to obtain the first code of the request entry and the candidate codes of the index entry.

It is to be noted that the above algorithm of encoding the index entry in this embodiment is also applicable to encoding the request entry, so as to ensure that the index entry and the request entry are encoded in a same manner.

Exemplarily, after obtaining the first code of the request entry, the client encrypts a constant-weight code by using a private key in the homomorphic encryption framework. A degree of the highest term in a polynomial in the homomorphic encryption framework is set to N, which is used to identify an encryption space range of a string. Then, the first code x satisfies x=x₁∥ . . . ∥xₜ, and when t=[m/N], a result of the first code x after encryption may be expressed as [\tilde{X}₁, . . . , \tilde{X}ₜ].

Exemplarily, relevant code for encoding the index entry is disclosed in this embodiment, specifically as follows:

```
$input : i ∈ [ n ] , m , k ∈ N with ( \begin{matrix}m \\ k\end{matrix} ) \geq n$
output: x ∈ CW(m,k)
  j:=i
  l:=k
  x:=0^{m}
  for m':= m-1,...,0 do
  $if j \geq ( \begin{matrix}{m}^{{}_{} ′} \\ l\end{matrix} ) then$
    x[m']:=1
    $j := j - ( \begin{matrix}{m}^{{}_{} ′} \\ l\end{matrix} )$
    l:=l-1
  end if
  if l=0 then
    break
  end if
end for
return x
```

Exemplarily, relevant code for encoding the request entry is also disclosed in this embodiment, specifically as follows:

```
input: kw∈KW, m,k ∈ N, a set of hash functions (Hi:|KW|→[m])
output: x∈CW(m,k)
  i:=1
  k′:=0
  x:=0^{m}
  while k′<k do
    h:=Hi(kw)
    if x[h]=0 then
      x[h]:=1
      k′:=k′+1
    else
      i:=i+1
    end if
  end while
  return x
```

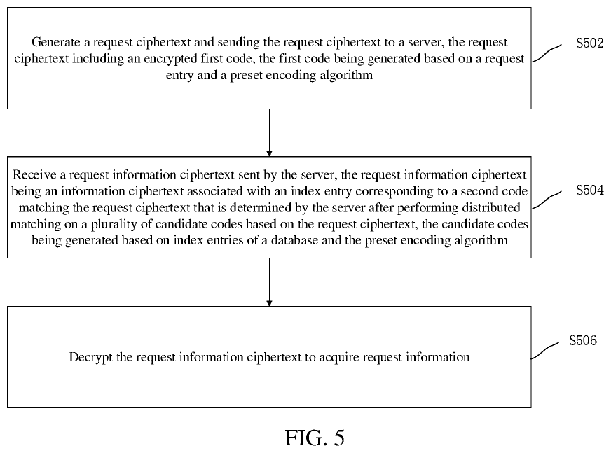

Referring to FIG. 5, FIG. 5 is a schematic flowchart of an information retrieval method according to another embodiment of the present disclosure.

In another embodiment, as shown in FIG. 5, the information retrieval method includes the following steps.

In S502, a request ciphertext is generated and sent to a server, the request ciphertext includes an encrypted first code, and the first code is generated based on a request entry and a preset encoding algorithm.

Specifically, the client receives a request entry inputted by the user, processes the request entry through the preset encoding algorithm, generates a first code, and encrypts the first code, to obtain a request ciphertext. After generating the request ciphertext, the client sends the request ciphertext to the server.

In S504, a request information ciphertext sent by the server is received, the request information ciphertext is an information ciphertext associated with an index entry corresponding to a second code matching the request ciphertext that is determined by the server after performing distributed matching on a plurality of candidate codes based on the request ciphertext, and the candidate codes are generated based on index entries of a database and the preset encoding algorithm.

Specifically, after receiving the request ciphertext, the server matches the plurality of candidate codes in parallel through distributed processing, so as to determine the second code matching the first code in the request ciphertext. After retrieving the second code matching the request ciphertext, the server determines the corresponding index entry of the database based on the second code, and sends an information ciphertext of the index entry, that is, the request information ciphertext, to the client. The client receives the request information ciphertext sent by the server.

In S506, the request information ciphertext is decrypted to acquire request information.

Specifically, after receiving the request information ciphertext sent by the server, the client decrypts the request information ciphertext based on a key to obtain request information therein.

Specifically, specific encoding, matching, and other processes in this embodiment have been elaborated in the above embodiments and will not be described in detail in this embodiment.

In this embodiment, the server processes a request from the user in an encrypted environment and returns encrypted request information to the client, so that the server cannot know a query object of the client while the client uses a database query service normally. At the same time, the server simultaneously performs correlation retrieval on the plurality of candidate codes through distributed processing, so that the retrieval process can support batch processing operations, which solves the technical problems of the high computational cost and low retrieval efficiency of the private information retrieval in the related art, leads to lower amortized overhead and faster processing of computing resources, and improves retrieval efficiency while ensuring privacy and security of the information retrieval process.

It should be understood that, although the steps in the flowcharts involved in the embodiments as described above are displayed sequentially as indicated by the arrows, the steps are not necessarily performed sequentially in the order indicated by the arrows. Unless otherwise clearly specified herein, the steps are performed without any strict sequence limitation, and may be performed in other orders. In addition, at least some steps in the flowcharts involved in the embodiments as described above may include a plurality of steps or a plurality of stages, and such steps or stages are not necessarily performed at a same moment and may be performed at different moments. The steps or stages are not necessarily performed in sequence, and the steps or stages and at least some of other steps or steps or stages of other steps may be performed in turn or alternately.

Based on the same inventive concept, embodiments of the present disclosure further provide an information retrieval apparatus 100 configured to implement the information retrieval method involved above. The implementation solution provided by the apparatus is similar to the implementation solution described in the above method. Therefore, specific limitations in one or more embodiments of the information retrieval apparatus 100 provided below may be obtained with reference to the limitations on the information retrieval method. Details are not described herein again.

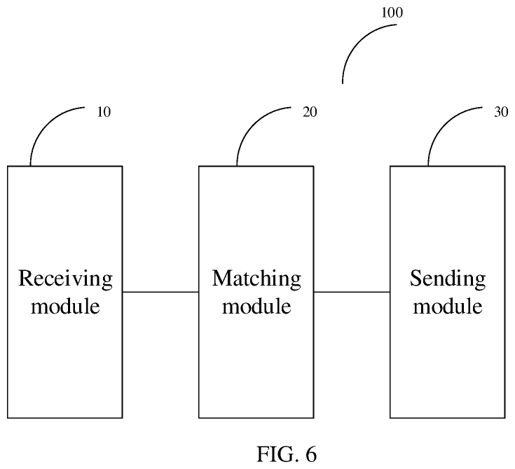

In an embodiment, as shown in FIG. 6, the information retrieval apparatus 100 includes:
a receiving module 10 configured to receive a request ciphertext sent by a client, the request ciphertext including an encrypted first code, the first code being generated based on a request entry of the client and a preset encoding algorithm;
a matching module 20 configured to perform distributed matching on a plurality of candidate codes based on the request ciphertext to determine a second code matching the request ciphertext, the candidate codes being generated based on index entries of a database and the preset encoding algorithm;
the matching module 20 being further configured to determine a plurality of first sequence positions corresponding to a preset character based on the candidate codes; and
acquire all target characters corresponding to the first sequence positions in the request ciphertext, and determine a matching result based on a product result of all the target characters;
the matching module 20 being further configured to perform a rotation operation on the request ciphertext sequentially based on each of the first sequence positions to obtain a plurality of rotated ciphertexts, a character at a preset sequence position in each of the rotated ciphertexts being the same as a character at the first sequence position in the corresponding request ciphertext; and
acquire target rotated characters corresponding to the preset sequence positions in the plurality of rotated ciphertexts, and determine the matching result based on a product result of all the target rotated characters;
the matching module 20 being further configured to, during each round of rotation, perform the rotation operation on the request ciphertext simultaneously based on the first sequence positions of the plurality of candidate codes to obtain the plurality of rotated ciphertexts and superimpose the plurality of rotated ciphertexts to obtain a combined rotated ciphertext; and
acquire the target rotated character corresponding to each of the preset sequence positions in the plurality of combined rotated ciphertexts obtained during a plurality of rounds of rotation, and determine a matching result of the corresponding candidate code based on a product result of all the target rotated characters corresponding to each of the preset sequence positions; and
a sending module 30 configured to send a request information ciphertext associated with the index entry corresponding to the second code to the client.

The information retrieval apparatus 100 further includes a selection vector establishment module.

The selection vector establishment module is configured to establish a selection vector, each component in the selection vector corresponding to a matching result of one of the candidate codes; and
determine the request information ciphertext associated with the index entry corresponding to the second code based on the selection vector and a plurality of index code information corresponding to the plurality of candidate codes.

The selection vector establishment module is further configured to perform, when lengths of the index code information are no higher than a preset threshold, a multiplication operation on the selection vector and an index information group to obtain the request information ciphertext; and
cut, when the lengths of the index code information are higher than the preset threshold, each of the index code information separately to obtain a plurality of sub index information groups, and rotate and add a multiplication result of the selection vector and each of the sub index information groups to obtain the request information ciphertext.

The selection vector establishment module is further configured to perform a rotation operation on the selection vector to obtain a rotated selection vector, and rotate the index information group correspondingly based on the rotation operation on the selection vector, to obtain a rotated index information group; and
determine the request information ciphertext associated with the index entry corresponding to the second code based on the rotated selection vector and the rotated index information group.

All or some of the modules in the foregoing information retrieval apparatus 100 may be implemented by using software, hardware, and a combination thereof. The foregoing modules may be built in or independent of a processor 21 of a computer device in a hardware form, or may be stored in a memory 22 of the computer device in a software form, so as to facilitate the processor 21 to invoke and perform operations corresponding to the foregoing modules.

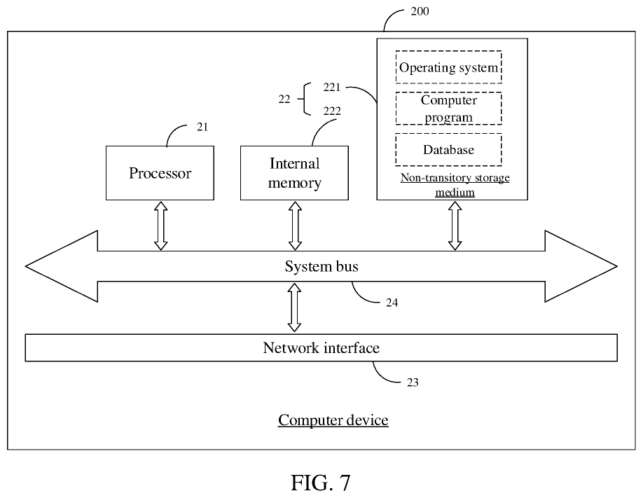

In an embodiment, a computer device 200 is provided. The computer device 200 may be a server, and a diagram of an internal structure thereof may be shown in FIG. 7. The computer device 200 includes a processor 21, a memory 22, and a network interface 23 connected through a system bus 24. The processor 21 of the computer device 200 is configured to provide computing and control capabilities. The memory 22 of the computer device 200 includes a non-transitory storage medium 221 and an internal memory 222. The non-transitory storage medium 221 stores an operating system, a computer program, and a database. The internal memory 222 provides an environment for running of the operating system and the computer program in the non-transitory storage medium 221. The database of the computer device 200 is configured to store data. The network interface 23 of the computer device 200 is configured to communicate with an external terminal over a network. The computer program is executed by the processor 21 to implement an information retrieval method. A display screen of the computer device 200 may be a liquid crystal display screen or an electronic ink display screen. The input apparatus of the computer device 200 may be a touch layer covering the display screen, or may be a key, a trackball, or a touchpad disposed on a housing of the computer device 200, or may be an external keyboard, touchpad, mouse, or the like.

Those skilled in the art may understand that, the structure shown in FIG. 7 is merely a block diagram of a partial structure related to the solution of the present disclosure, and does not limit the computer device 200 to which the solution of the present disclosure is applied. Specifically, the computer device 200 may include more or fewer components than those shown in the figure, or some components may be combined, or a different component deployment may be used.

In an embodiment, a computer device 200 is provided, including a memory 22 and a processor 21. A computer program is stored in the memory 22. The processor 21, when executing the computer program, implements the following steps:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm; and
sending a request information ciphertext associated with the index entry corresponding to the second code to the client.

In an embodiment, a computer-readable storage medium is provided. The computer-readable storage medium stores a computer program. When the computer program is executed by the processor 21, the following steps are implemented:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm; and
sending a request information ciphertext associated with the index entry corresponding to the second code to the client.

In an embodiment, a computer program product is provided, including a computer program. When the computer program is executed by the processor 21, the following steps are implemented:
receiving a request ciphertext sent by a client, the request ciphertext including an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm; and
sending a request information ciphertext associated with the index entry corresponding to the second code to the client.

It is to be noted that, user information (including, but not limited to, user equipment information, user personal information, etc.) and data (including, but not limited to, data for analysis, stored data, displayed data, etc.) involved in the present disclosure are information and data authorized by the user or fully authorized by all parties.

Those of ordinary skill in the art may understand that some or all procedures in the methods in the foregoing embodiments may be implemented by a computer program instructing related hardware, the computer program may be stored in a non-transitory computer-readable storage medium, and when the computer program is executed, the procedures in the foregoing method embodiments may be implemented. Any reference to the memory, database, or other media used in the embodiments provided in the present disclosure may include at least one of a non-transitory memory and a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, and the like. The transitory memory may include a random access memory (RAM) or an external cache memory. By way of illustration instead of limitation, the RAM is available in a variety of forms, such as a static RAM (SRAM) or a dynamic RAM (DRAM). The database involved in various embodiments provided in the present disclosure may include at least one of a relational database and a non-relational database. The non-relational database may include a blockchain-based distributed database and the like, and is not limited thereto. The processor 21 involved in various embodiments provided in the present disclosure may be a general-purpose processor, a central processing unit, a graphics processor, a digital signal processor, a programmable logic device, a data processing logic device based on quantum computing, and the like, and is not limited thereto.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, and their description is specific and detailed, but cannot therefore be understood as a limitation on the patent scope of the present disclosure. It should be noted that those of ordinary skill in the art may further make variations and improvements without departing from the conception of the present disclosure, and these all fall within the protection scope of the present disclosure. Therefore, the patent protection scope of the present disclosure should be subject to the appended claims.

What is claimed is:

1. An information retrieval method, comprising:
receiving a request ciphertext sent by a client, the request ciphertext comprising an encrypted first code, the first code being generated based on a request entry of the client and a preset encoding algorithm;
performing distributed matching on a plurality of candidate codes based on the request ciphertext to determine a second code matching the request ciphertext, the candidate codes being generated based on index entries of a database and the preset encoding algorithm;
sending a request information ciphertext associated with the index entry corresponding to the second code to the client.

2. The information retrieval method of claim 1, wherein the performing distributed matching on the plurality of candidate codes based on the request ciphertext comprises:
determining a plurality of first sequence positions corresponding to a preset character based on the candidate codes;
acquiring all target characters corresponding to the first sequence positions in the request ciphertext, and determining a matching result based on a product result of all the target characters.

3. The information retrieval method of claim 2, wherein the acquiring all the target characters corresponding to the first sequence positions in the request ciphertext, and determining the matching result based on the product result of all the target characters comprises:
performing a rotation operation on the request ciphertext sequentially based on each of the first sequence positions to obtain a plurality of rotated ciphertexts, a character at a preset sequence position in each of the rotated ciphertexts being the same as a character at the first sequence position in the corresponding request ciphertext;
acquiring target rotated characters corresponding to the preset sequence positions in the plurality of rotated ciphertexts, and determining the matching result based on a product result of all the target rotated characters.

4. The information retrieval method of claim 3, wherein a number of the first sequence positions corresponding to each of the candidate codes is the same, and the performing distributed matching on the plurality of candidate codes based on the request ciphertext to determine the second code matching the request ciphertext comprises:
during each round of rotation, performing the rotation operation on the request ciphertext simultaneously based on the first sequence positions of the plurality of candidate codes to obtain the plurality of rotated ciphertexts and superimpose the plurality of rotated ciphertexts to obtain a combined rotated ciphertext;
acquiring the target rotated character corresponding to each of the preset sequence positions in the plurality of combined rotated ciphertexts obtained during a plurality of rounds of rotation, and determining a matching result of the corresponding candidate code based on a product result of all the target rotated characters corresponding to each of the preset sequence positions.

5. The information retrieval method of claim 1, further comprising: after the performing distributed matching on the plurality of candidate codes based on the request ciphertext to determine the second code matching the request ciphertext,
establishing a selection vector, each component in the selection vector corresponding to a matching result of one of the candidate codes;
determining the request information ciphertext associated with the index entry corresponding to the second code based on the selection vector and a plurality of index code information corresponding to the plurality of candidate codes.

6. The information retrieval method of claim 5, wherein the components of the selection vector comprise a binary number 0 corresponding to a non-matching result and a binary number 1 corresponding to a matching result, and the determining the request information ciphertext associated with the index entry corresponding to the second code based on the selection vector and the plurality of index code information corresponding to the plurality of candidate codes comprises:
performing, when lengths of the index code information are no higher than a preset threshold, a multiplication operation on the selection vector and an index information group to obtain the request information ciphertext;
cutting, when the lengths of the index code information are higher than the preset threshold, each of the index code information separately to obtain a plurality of sub index information groups, and rotating and adding a multiplication result of the selection vector and each of the sub index information groups to obtain the request information ciphertext.

7. The information retrieval method of claim 5, wherein the determining the request information ciphertext associated with the index entry corresponding to the second code based on the selection vector and the plurality of index code information corresponding to the plurality of candidate codes comprises:
performing a rotation operation on the selection vector to obtain a rotated selection vector, and rotating the index information group correspondingly based on the rotation operation on the selection vector, to obtain a rotated index information group;
determining the request information ciphertext associated with the index entry corresponding to the second code based on the rotated selection vector and the rotated index information group.

8. The information retrieval method of claim 1, wherein each of the candidate codes is a binary string, the binary string comprising a preset number of binary numbers 1.

9. An information retrieval method, comprising:
generating a request ciphertext and sending the request ciphertext to a server, the request ciphertext comprising an encrypted first code, the first code being generated based on a request entry and a preset encoding algorithm;
receiving a request information ciphertext sent by the server, the request information ciphertext being an information ciphertext associated with an index entry corresponding to a second code matching the request ciphertext that is determined by the server after performing distributed matching on a plurality of candidate codes based on the request ciphertext, the candidate codes being generated based on index entries of a database and the preset encoding algorithm;
decrypting the request information ciphertext to acquire request information.

10. An information retrieval apparatus, comprising:
a receiving module configured to receive a request ciphertext sent by a client, the request ciphertext comprising an encrypted first code, the first code being generated based on a request entry of the client and a preset encoding algorithm;
a matching module configured to perform distributed matching on a plurality of candidate codes based on the request ciphertext to determine a second code matching the request ciphertext, the candidate codes being generated based on index entries of a database and the preset encoding algorithm;
a sending module configured to send a request information ciphertext associated with the index entry corresponding to the second code to the client.

11. A computer device, comprising a memory and a processor, a computer program being stored in the memory, wherein the processor, when executing the computer program, implements steps of the method of claim 1.

12. A computer-readable storage medium, storing a computer program, wherein when the computer program is executed by a processor, steps of the method of claim 1 are implemented.

13. A computer program product, comprising a computer program, wherein when the computer program is executed by a processor, steps of the method of claim 1 are implemented.
